(19) United States
(12) Patent Application Publication
(10) Pub. No.: US 2003/0096076 A1
(43) Pub. Date: May 22, 2003

(54) Perforated tape

(76) Inventor: Donald Allison, Anderson Island, WA (US)

Correspondence Address: BLACK LOWE & GRAHAM, 816 SECOND AVE., SEATTLE, WA, 98104, US

(21) Appl. No.: 09/989,852

(22) Filed: Nov. 19, 2001

(51) Int. Cl. B32B 3/10

(52) U.S. Cl. 428/43

(57) ABSTRACT

The present invention discloses a specialty masking tape for painters and contractors that will dispense a consistent sized rectangular shaped tape with straight edges that is useful for covering electrical outlets, switches, and phone jacks.

### FIELD OF THE INVENTION

This invention relates generally to tape and, more specifically, to perforated masking tape.

### BACKGROUND OF THE INVENTION

Painters, drywall texture installers, and other craftsmen typically use masking tape for a variety of purposes. Principally, masking tape is used to cover or “mask” objects that are intended not to be painted or textured. One principal object found in homes and buildings that is covered when painting is an electrical outlet or light switch. In order to protect them, the painter removes the cover plate, then tears off a section of masking tape for use in covering the outlet or switch.

While masking tape covers well and is easy to tear, it is not easy to tear in a straight line. The jagged tape edge often leaves a portion of the outlet or switch exposed and likely to be damaged or spotted with paint or plaster. None of the present methods are suitable for easily and adequately obtaining a section of tape properly sized and shaped to cover a switch or outlet. Scissors are impractical, hazardous, and inefficient to use on a job site. A jagged cutting edge as is sometimes provided for transparent tape is also awkward and imprecise. In short, nothing available today is suitable.

In other settings, tape makers have produced rolls of tape that are pre-perforated and therefore easier to tear. In each case, however, the type of tape is such that it is difficult to tear without perforations. For example, U.S. Pat. No. 5,496,605 to Augst et al. describes a perforated roll of surgical tape. This is extremely useful in the surgical setting because surgical tape is tough and also because doctors often must tear the tape quickly. It has not occurred to others to perforate masking tape, perhaps principally because it is so easy to tear without perforations. Moreover, most masking tape uses do not require precisely cut edges or precisely sized sections.

The particular use of masking tape for light switches, electrical outlets, and the like, however, requires a relatively straight cut and a tape section of adequate size to cover the object. Accordingly, there is a need for a roll of masking tape that can be easily separated into uniform sections for application on a light switch, electrical outlet, and the like.

### SUMMARY OF THE INVENTION

The present invention comprises a masking tape wrapped around a core to form a roll having a series of equally spaced tape segments separated separation lines that are preferably perforated lines. The perforations on the masking tape allow the tape to be easily torn by hand. The masking tape dispenses appropriately sized rectangular sections to cover electrical outlets, light switches, phone jacks and other utility outlets before painting. These utility outlets are usually located on the surface of a wall.

In accordance with further aspects of the invention, the perforations include, one elongated segment preferably placed at opposite edges of the tape and a series of smaller perforations located in-between. In accordance with other aspects of the invention, the core is dyed with a bright color to distinguish the present invention from a standard roll of masking tape.

### BRIEF DESCRIPTION OF THE DRAWINGS

The preferred and alternative embodiments of the present invention are described in detail below with reference to the following drawings.

FIG. 1 is a perspective view of a roll of masking tape manufactured in accordance with the present invention;

FIG. 2 is a top view of masking tape with perforations; and

FIG. 3 is an exemplary view of a masking tape section applied to an electrical outlet.

### DETAILED DESCRIPTION OF THE PREFERRED EMBODIMENT

FIG. 1 is a perspective view of a roll of masking tape manufactured in accordance with the present invention. The roll of masking tape 10 includes an internal cylindrical core 12 upon which a length of connecting tape segments 14 has been wound. As illustrated, the tape terminates in an outer edge 16 and is shown partially unwound from the roll 10. Generally, the masking tape is defined as tape that has an adhesive on one side 18 and is used in a variety of ways including covering surfaces when painting. The adhesive and the structure of the tape are preferably the same as found in a standard roll of masking tape. In a preferred embodiment of the present invention, a standard length of masking tape is 60 yards and is rolled upon a cylindrical core dyed in a bright color to distinguish it from the standard 2 inches by 60-yard roll of masking tape.

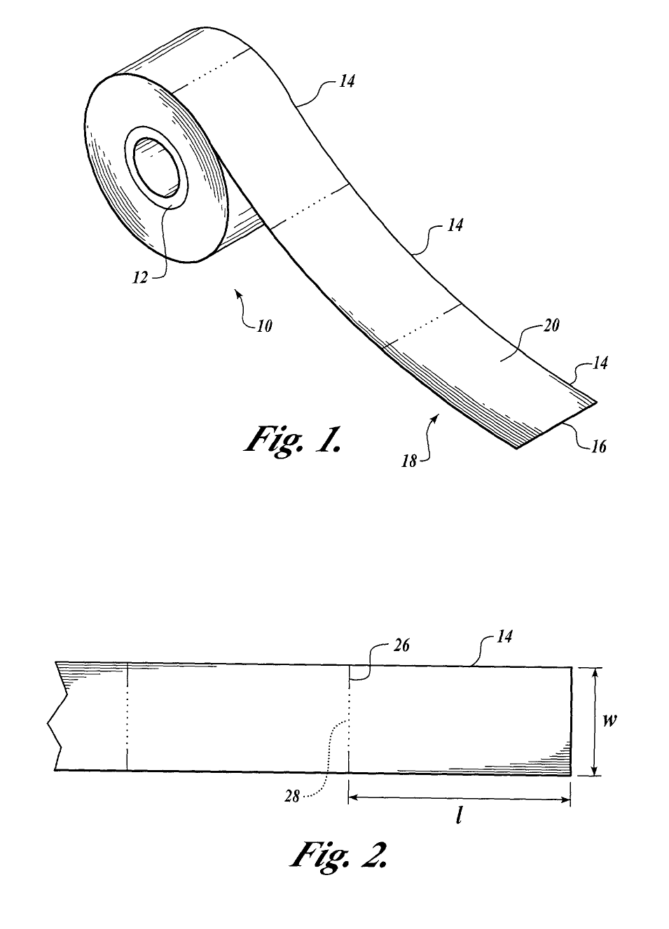

As illustrated in FIG. 1 and FIG. 2, a tape segment 14 comprises an adhesive side 18 and a non-adhesive side 20, a width w, and a length l. The perforations are preferably spaced such that when torn, the resulting section of tape covers an electrical outlet or wall switch. In the preferred embodiment, the tape width w is two inches and the length l between perforations is 3⅝ inches. In order to cover fully, the width w could be as small as 1⅜ inches, while the length l may be as long as 4¼ inches. If the length is too great, the tape will bunch up or extend beyond the wall opening. If either the width or length are too small, the tape section will leave part of the outlet or switch exposed.

The tape is torn via a separation line extending from a first tape edge laterally to an opposing tape edge. Preferably, the separation line comprises perforations, but may alternatively comprise scoring, indentations, Or other means to weaken the tape so that it will tear on the separation line when pulled. The preferred form of perforation includes a first elongated cut 26 extending from one edge of the tape laterally toward the center, running perpendicular to the length of the tape. A second elongated cut 26 extends from the opposite edge toward the tape center. A series of smaller perforations 28 joins the first and second elongated cuts 26, as best seen in FIG. 2. Though this is the preferred form of perforating, other means may be used. These perforation lines will allow the sections of tape to be dispensed and easily removed from the tape roll without using scissors or a cutting tool. In addition, the perforations prevent jagged edges as with the standard roll of masking tape.

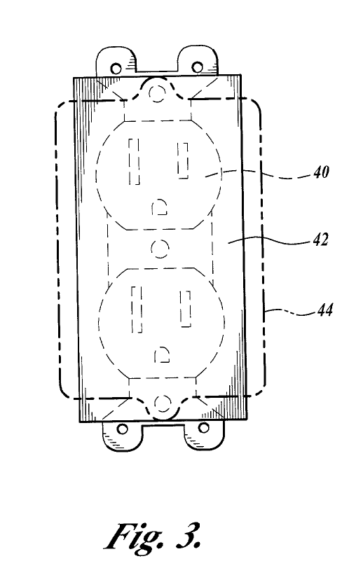

FIG. 3, is an exemplary view of the masking tape employed in accordance with the present invention. An electrical outlet 40 is illustrated, although the masking tape segment is sized to fit any utility outlet and is not limited to phone jacks, light switches, and power outlets. As described, the masking tape section 42 is sized appropriately to cover an outlet 40 in its entirety. Preferably, the tape section 42 is slightly smaller than the wall opening 44, but larger than the outlet 40.

While the preferred embodiment of the invention has been illustrated and described, as noted above, many changes can be made without departing from the spirit and scope of the invention. Accordingly, the scope of the invention is not limited by the disclosure of the preferred embodiment.

I claim:

1. A roll of masking tape, comprising:
(a) a core; and
(b) a length of masking tape wound around the core;
(c) wherein the masking tape comprises (i) an adhesive side and a non-adhesive side and (ii) a plurality of longitudinally spaced, laterally extending separation lines, each of the separation lines spaced longitudinally to define a segment of the tape sized to cover a standard electrical wall outlet.

2. The roll of masking tape of claim 1, wherein the separation lines further comprise perforations.

3. The roll of masking tape of claim 2, wherein the length of tape further comprises a first edge extending longitudinally and the perforations further comprise a first elongated cut extending from the first edge to a first termination point inward from the edge, and a plurality of perforations extending axially away from the termination point.

4. The roll of masking tape of claim 3, wherein the segment of tape has a length and a width and wherein the length is less than 4¼ inches and the width is greater than 1⅜ inches.

5. The roll of masking tape of claim 4, wherein the length of tape further comprises a second edge opposite the first edge and the perforations further comprise a second elongated cut extending from the second edge to a second termination point inward from the second edge.
